(19) United States
(12) Patent Application Publication
(10) Pub. No.: US 2016/0147404 A1
(43) Pub. Date: May 26, 2016

(54) NEW USES OF SMARTPHONES AND COMPARABLE MOBILE DIGITAL TERMINAL DEVICES

(71) Applicant: Dirk KEUNE, Ettlingen (DE)

(72) Inventor: Dirk Keune, Ettlingen (DE)

(73) Assignee: READIO GMBH, Karlsruhe (DE)

(21) Appl. No.: 14/775,991

(22) PCT Filed: Mar. 12, 2014
(86) PCT No.: PCT/EP2014/054883

§ 371 Date: Dec. 30, 2015

Related U.S. Application Data
(60) Provisional application No. 61/776,980, filed on Mar. 12, 2013.

(51) Int. Cl. G06F 3/0485; H04N 5/225; G06F 3/0484; A63F 13/825; A63F 13/23; A63F 13/212; A63F 13/213; G06F 3/01; A63F 13/53

(52) U.S. Cl. CPC G06F 3/0485; G06F 3/011; H04N 5/225; G06F 3/04842; A63F 13/53; A63F 13/23; A63F 13/212; A63F 13/213; A63F 13/825

(57) ABSTRACT

New uses of smartphones (1, 1′) and comparable mobile digital terminal devices are proposed. This includes uses of a digital terminal device, preferably in the form of a mobile device such as a smartphone or the like, wherein special application software (App) is stored and run on the terminal device and wherein the terminal device (1) is advantageously used together with a holding device (2) arranged or to be arranged on the head of a user (5), particularly in accordance with EP 2 103 862 or EP 2 562 462 or US 2012/0175394 or DE 20 2009 009 326 or DE 24 20 2013 000 740, so that the hands (6) of the user (5) are free and thus additional application possibilities arise during the use of the terminal device (1), for example by using an external controller. These additional application possibilities relate inter alia to e-book readers of a new type, social games and toys, virtual configurators, for purchasing a motor vehicle for example, a double camera usage in smartphones, music stands of a new type for learning musical instruments and new possibilities for remotely controlling electronic objects such as toys or the like.

### BACKGROUND

The invention relates to uses of a digital terminal device, preferably in the form of a mobile device, such as a smartphone or the like, special application software respectively being stored and executed on the terminal device, and the terminal device advantageously being used together with a holding apparatus arranged or to be arranged on the head of a user according to EP2103862 or EP2562462 or US2012/0175394 or DE 20 2009 009 326 or DE 20 2013 000 740, with the result that the user's hands are free and the user discovers additional possible applications during use of the terminal device.

Smartphones and comparable digital (mobile) terminal devices are nowadays widespread and many people can scarcely imagine everyday life without them. They make it possible to use varied media contents, such as text, images, videos and audio contents, without local restrictions, they make it possible to use social networks, they support digital communication, for example using telephony and (video) chat, and they enable digital gaming experiences. They can be functionally adapted and expanded in virtually any desired manner using downloadable software, so-called apps.

Some of the new possible applications of smartphones and other terminal devices mentioned at the outset are described below and are defined in more detail in the accompanying claims.

A first aspect of the invention relates to a new generation of e-book readers or reading devices. These are understood as meaning devices which are intended or set up to make contents which were formerly printed on paper and can be read or viewed by people available in digital form.

There are different embodiments of e-books nowadays. They can be stored and read on a laptop, a tablet PC, a cellphone (smartphone) or on special e-book readers. However, the reading of e-books on the widespread smartphones, in particular, is not very convenient since the screens are comparatively small, which makes readability difficult, and since the constant holding of the smartphone in the hand may be tiring. In addition, use has hitherto been restricted to the mere reading of text in a conventional manner.

WO 2014/011884 A1 discloses a method and an apparatus, with which and in which isolated parts (words) of text are displayed at a fixed position on a display individually and in rapid succession in order to increase the reading speed in this manner. This method has only very limited suitability for the relaxed reading of longer texts because a high degree of concentration is needed to follow the words which flash in quick succession. In addition, desirable “enrichment” of the text with further media contents is ruled out.

### SUMMARY

The invention is based on the object of remedying this and opening up new fields of use for digital terminal devices, in which case use is not intended to remain restricted to the mere reading of text in a conventional manner and “enrichment” of the text with further media contents is intended to be possible, in particular.

This object is achieved by means of application software (“app” or “software app” for short) for digital terminal devices. The object is likewise achieved by means of an accordingly programmed (configured) digital terminal device on which the application software is executed.

The application software according to the invention for digital terminal devices, preferably mobile devices, such as smartphones or the like, preferably in downloadable form or in a form stored on a terminal device, is distinguished by the fact that, during its execution, a relevant terminal device provides an application having the following properties: A) the application is designed to access a file containing text which can be read by a user of the terminal device, that is to say the e-book, for example; and B) the application is designed to display the text sequentially in the form of scrolling text on a display device (the display) of the terminal device. The application software (app) according to the invention is also referred to as “readio app” or simply “readio” below.

A digital terminal device according to the invention is distinguished by the fact that application software is stored and can be executed on it, during the execution of which the terminal device A) accesses a file containing text which can be read by a user of the terminal device, that is to say the e-book, for example; and B) the terminal device is designed to display the text sequentially in the form of scrolling text on a display device (the display) of the terminal device.

The invention is not restricted to mobile devices: for example, the readio app can also be used as a so-called (browser) plug-in or in another form on stationary terminal devices. The novel reading principle associated with this is therefore also available on normal computers—that is to say in a browser for example—by means of a corresponding plug-in. The reader can therefore change to another mode, for example on a news page, and can then read the contents using the “readio method” provided by the readio app.

One development of the application software according to the invention provides for the application to also be designed to provide the user with a user interface which can be used by the user to control a display speed of the text, preferably a scrolling speed of the scrolling text, and/or a display size of the text or scrolling text, preferably by means of an external controller, for example a Bluetooth controller, which can be or is connected to the terminal device.

However, the invention is not restricted to the use of an external controller. In particular, the practice of controlling the readio app by means of at least one accordingly sensitive area of a touchscreen also comes into consideration, which is nowadays generally known from smartphones or the like.

In this case, provision may be made for the text to move only when and only for as long as the user actuates an operating element, for example a pushbutton on the controller or an accordingly sensitive area of a touchscreen.

Another development of the application software according to the invention provides for the application to also be designed to display further media contents, such as acoustic contents, preferably music or sounds, or optical contents, preferably images or videos, in addition or as an alternative to the text or the scrolling text on the basis of control data in the file containing the text by means of the terminal device, preferably automatically, that is to say without active operation by the user.

This concomitantly includes, for example, a background image which, in terms of contents, matches the currently displayed text and can move at a speed which differs from the scrolling text, preferably a slower speed.

These optical contents, preferably images or videos, can be displayed inside the text or scrolling text or inside at least one display area of the display device (display) which is locally separate therefrom. With a corresponding development of the invention, it is also possible to “introduce” images or the like with the scrolling text, to then “couple” them out of the scrolling text and to “store” them in the locally separate display area, for example for a certain time (until a new image is “introduced” and “coupled out”). The image which has been coupled out may symbolize a link and may be accordingly selected in order to follow the link, for example for background information. This concept is also highly suitable for advertising contents.

With a corresponding development of the invention, the readio app is highly suitable for use in the manner of navigated reading: since the text in the readio app runs in one line, complex text can be navigated in a considerably easier manner for the reader. In a similar manner to a website, text can be acquired in a type of site map and can be subdivided into various categories. The reader reading the contents using the readio app can then respectively choose, at the various locations, where he now wishes to continue to read by virtue of selectable alternatives respectively being displayed for the reader. This is not readily possible with conventional reading methods. Readio therefore makes it possible to read complex text on various levels. Text which is popular with children, in particular, and in which the reader himself concomitantly determines the course of the story by selecting alternatives, may also be implemented in this manner.

The readio concept can also be used together with a so-called social plug-in: in this case, the intention is to make it possible for a user to publish passages of text from contents which he is currently reading on the social web using a few steps. A corresponding development of the invention provides for simple tapping on a touchscreen of the terminal device used, for example, to be able to be used to select the start and end of the passage to be marked and for this selected text to then be able to be published on Facebook or other portals using a social web interface provided.

With a corresponding development of the invention, a further function (commentary function) makes it possible to store voice or text notes at particular places in the text in order to subsequently, for example back at the workstation, make changes to the text. Although this functionality is already known as such, the practice of commenting on text in the discussed form is currently not yet possible on mobile terminal devices, in particular, on account of the conventional display of the text. The readio reading method provides a considerable simplification here.

All of the discussed developments of the invention similarly also relate to a digital terminal device which is set up, in particular in terms of software, to implement the functions of the application software.

In this context, the invention also relates to a special data format for use with application software according to the invention. This data format (also referred to as “rdx” format below) provides for the data format to contain, in addition to text which can be read by people at least after being suitably displayed by a digital terminal device, control data which, on the basis of predetermined passages, refer to additional media contents, such as acoustic contents, preferably music or sounds, or optical contents, preferably images or videos, which contents are stored inside the same data format or separately, in order to cause the terminal device, when the text is displayed sequentially, preferably in the form of scrolling text, by a digital terminal device, preferably a mobile device, such as a smartphone or the like, to display the additional media contents in addition or as an alternative to the text or the scrolling text on the basis of the reaching of the control data in a time-controlled manner.

In this context, with a corresponding development of the invention, it is possible, for example, to design a blog reader or the like using the readio concept: an interface in conventional editing systems for setting up websites (for example WordPress, Jomla or similar systems) can be used to automatically generate an rdx file using a corresponding plug-in in order to allow blog subscribers to read the subscribed contents directly as a readio file using said app.

The use of a digital terminal device, preferably a mobile device, such as a smartphone or the like, to display readable text and additional media contents based on the text is also proposed, which use is distinguished by the fact that application software according to the first aspect of the invention is executed on the terminal device and accesses a file containing the data format according to the invention, the terminal device, in a configuration as a mobile device, preferably being used together with a holding apparatus to be arranged on the head of a user according to EP2103862 or EP2562462 or US2012/0175394 or DE 20 2009 009 326 or DE 20 2013 000 740. Such a holding apparatus is also referred to as “Headflat®” below.

If the text here and below refers to a “smartphone”, this naturally also always concomitantly includes other (digital) terminal devices, in particular mobile devices. The use of such devices with the Headflat® naturally presupposes that the relevant devices are not too heavy and/or too large.

The solution according to the first aspect of the invention does not necessarily presuppose the use of the Headflat® but provides definitely more options in conjunction with it.

On the one hand, according to the statements above, provision may be made for the software app, which is used to reproduce the e-book, that is to say a corresponding (text) file, to be configured in such a manner that the text is displayed in a scrolling line or as scrolling text, for example like in a teleprompter. This means that the text runs across the screen in a scrolling line, preferably horizontally, that is to say from right to left or from left to right. As a result of the programming, it is also preferably possible for the user of the smartphone or the app to independently set the size of the font and the throughput speed of the line. This can be implemented, for example, by means of a commercially available Bluetooth controller.

Furthermore, as already stated, provision may be made for the (text) contents, which run through on the display for each scrolling line, to be supplemented with further media contents. If, for example, someone is shot in a crime e-book, a bullet can be displayed at precisely this location during reading in accordance with corresponding control data in the e-book file, the sound of which bullet is output via an audio output of the terminal device. A novel mixture of an e-book and an audio book is therefore produced. Background images or background music may also change in a suitable manner for the scene described.

During another application, a normal article in a newspaper, for example, which shows a report from a rainforest, may be provided as a controlled mixture of text, images and sounds, which mixture has been precisely matched in terms of time by the editor in advance using the control data which have been introduced. Newspaper or magazine articles are currently always composed only of blocks of text with more or less suitably inserted images. However, the reader is not guided during reading but rather can or must choose the order of reading and viewing the images himself. As a result of the proposed solution, the editor can provide the reader with better guidance and can construct the contents in a more structured manner.

This is particularly suited, but without restriction, to digital magazines, especially motoring magazines or travel magazines, and vocabulary trainers (pronunciation guides).

A second aspect of the invention deals with “board games” in the further sense, that is to say (party) games in which a game board (“board”) or a similar real object (toy) is used.

Board games have their fixed place in society but are being increasingly usurped and surpassed by digital versions. Therefore, many manufacturers of board games are attempting to combine the conventional board games with digital options. This is usually implemented by means of so-called augmented reality applications. In this case, the camera of a tablet PC (as a special terminal device), for example, is used to reproduce a real-time recording of the board game on the screen of the terminal device and said recording is mixed with digital contents. The user is therefore “virtually” provided with a digital display of game Figures, houses, vehicles, aircraft or other objects. The core problem is that the manufacturers generally use a tablet PC in order to achieve this result. However, these are uncomfortable to handle and are relatively heavy. The invention is based on the object of remedying this.

This object is achieved by means of application software (“app” or “software app” for short) for digital terminal devices.

The application software according to the invention for digital terminal devices in the form of mobile devices, such as smartphones or the like, preferably in downloadable form or in a form stored on a terminal device, is distinguished by the fact that, during execution of the software, a relevant terminal device provides an application having the following properties: A) the application is designed to provide a digital gaming environment for a toy, in particular a digital version of a board game which is known per se or was specifically developed for the application, which board game or toy comprises a game board or another physical object of a previously known geometry; and B) the application is designed to control a camera device of the terminal device and/or to use its image data and, on the basis of the image data, after initial optical identification of a predetermined real object, preferably the game board or toy, to dynamically display virtual game objects, such as Figures or objects, in a spatial relationship with the real object depending on a game situation using a display device of the terminal device.

One development of the application software provides for the application to also be designed to provide the user with a user interface which can be used by the user to control game play, preferably by means of an external controller which can be or is connected to the terminal device, most preferably a Bluetooth controller.

Another development of the application software provides for the application to also be designed to communicate, via corresponding communication devices of the terminal device, with a further terminal device which executes the same application software in order to provide a multiplayer gaming environment with a plurality of players.

Yet another development of the application software provides for the application to also be designed to display, for the relevant player or user, only a part of a game situation which is intended for the player or user, for example only his own game objects.

The object is also achieved by means of the use of a digital terminal device in the form of a mobile device, such as a smartphone or the like, on which terminal device application software according to the second aspect of the invention is executed, the terminal device being used together with a holding apparatus to be arranged on the head of a user according to EP2103862 or EP2562462 or US2012/0175394 or DE 20 2009 009 326 or DE 20 2013 000 740.

The solution according to the invention therefore initially involves using a commercially available smartphone or the like instead of a tablet PC for the described digital support and clamping said smartphone or the like in a Headflat®. As a result, the player's hands are free, the player can move freely and can cast dice, for example, and can thereby virtually permanently use the mixed state of the two worlds (real board game or toy and virtual, digital contents).

This also enables completely new game ideas. Known games, for example “Mensch ärgere Dich nicht” or “Schiffe versenken”, can be newly implemented, for example. In the case of “Schiffe versenken”, it has hitherto been necessary to construct barriers so that the opponent could not see the arrangement of the player's own ships. This is currently no longer necessary since the player's own ships are preferably visible only on the player's own screen in a multiplayer environment. The opponent therefore cannot see them on the board. The board is then used only as a framework for delimitation and as recognition for the executed software which requires a fixed point as a display basis in order to dynamically display, after initial optical identification of a predetermined real object, that is to say preferably the game board or another toy, virtual game objects, such as Figures or objects, in a spatial relationship with the real object depending on a game situation using a display device of the terminal device.

Within the scope of a corresponding configuration, the invention therefore involves using in combination smartphones (and other similar devices) together with the Headflat® and optionally a (Bluetooth) controller using augmented reality. This combination enables game ideas which were previously impossible since the device for displaying the additional virtual contents could not be permanently held in the hand.

This is particularly suitable, but without restriction, for all common board games, for example chess, for virtual pets, for “normal toys”, for example Playmobil®, or for construction sets/model making, in particular Lego® models.

A third aspect of the invention relates to virtual configurators, as can be used when buying automobiles, houses or furniture, for example.

If, for example and without restriction, an automobile showroom is entered nowadays, various automobiles are seen in the display. If the desired color or special equipment is not available in the display, the seller has various options of nevertheless showing them to the customer, for example on his computer using programs from the manufacturers, in a brochure or in product videos. The problem here is that the customer cannot be provided with any added value in this manner in comparison with access from home since the manufacturers usually have professional websites on which three-dimensional views of the vehicles can be retrieved. The invention is based on the object of remedying this.

This object according to the third aspect of the invention is achieved by means of application software for digital terminal devices in the form of mobile devices, such as smartphones or the like, preferably in downloadable form or in a form stored on a terminal device, during the execution of which a relevant terminal device provides an application having the following properties: A) the application is designed to provide and display a digital version of an object known per se, such as an automobile or a house, as a virtual object; and B) the application is designed to control a camera device of the terminal device and/or to use its image data and, on the basis of the image data, after initial optical identification of a predetermined real object, preferably an image code, to dynamically display additional virtual objects or properties, such as equipment features, colors, surfaces or attachments, in a spatial relationship with the virtual object on the basis of a selection and/or position of the terminal device user using a display device of the terminal device.

One development of the application software according to the invention provides for the application to also be designed to provide the user with a user interface which can be used by the user to select the additional virtual objects or properties, preferably by means of an external controller which can be or is connected to the terminal device, most preferably a Bluetooth controller.

Another development of the application software according to the invention provides for the application to also be designed to display, for the user, additional information relating to a current selection from a virtual object and additional virtual objects or properties using a display device of the terminal device, in particular price information, delivery information or the like.

The use of a digital terminal device in the form of a mobile device, such as a smartphone or the like, is also proposed, which use is distinguished by the fact that application software according to the invention in accordance with the third aspect of the invention is executed on the terminal device, the terminal device being used together with a holding apparatus to be arranged on the head of a user according to EP2103862 or EP2562462 or US2012/0175394 or DE 20 2009 009 326 or DE 20 2013 000 740.

In combination with the Headflat® and the described augmented reality application, the automobile showroom (or another company) can provide the customer with any possible configuration of a new automobile (or another goods item) virtually in the showroom. The seller preferably gives the customer a Headflat® with a smartphone or a similar device. The customer must then face a particular point at which an image code for the augmented reality application is arranged, for example on the floor. After initial optical identification of a predetermined real object, here specifically the image code, the desired automobile, possibly with additional virtual objects or properties, such as equipment features, colors, surfaces or attachments, then appears at this point for the customer in a spatial relationship with the virtual object, here specifically the automobile, depending on a selection and/or position of the terminal device user.

With a corresponding development of the invention, the customer can now change the colors and other equipment features on the vehicle using the controller in his hand. Another advantage is that the customer can virtually walk around the automobile. This has hitherto not been possible with all other technical proposals which can be offered to the customer by the automobile showroom.

This approach is particularly suitable for automobile showrooms and motorcycle dealers, caravan and motorhome dealers, architects and construction companies (in order to project houses and other objects into a landscape or to make them accessible) and for furniture showrooms and interior designers (in order to project paintings and/or furniture into a room, for example).

A fourth aspect of the invention deals with the dual camera use in smartphones or other terminal devices having a front camera and a rear camera.

Modern smartphones usually have a camera on the front and a camera on the rear. The camera on the front with a high resolution is suitable for regular photos. The camera on the rear, that is to say on the side on which the display is usually also situated, which often produces a lower resolution and therefore a poorer image quality, is generally suitable for video chats and “selfies”. There is currently no app which addresses the two cameras at the same time in terms of software and stores the result, that is to say virtually a divided display (split screen), as an output or forwards it to another receiver as a (video) signal during a chat.

Therefore, the fourth aspect of the invention is based on the object of making it possible to jointly use the image data from both cameras in order to achieve added value for users.

This object is achieved by means of application software for digital terminal devices in the form of mobile devices with a front camera and a rear camera, such as smartphones or the like, preferably in downloadable form or in a form stored on a terminal device, during the execution of which a relevant terminal device provides an application having the following properties: A) the application is designed to control the front camera and the rear camera substantially at the same time and/or to use their image data at the same time; and B) the application is designed to dynamically display the image data from the front camera and from the rear camera at the same time using a display device of the terminal device and/or to transmit said image data to a remote, further terminal device, preferably a further mobile device, and to dynamically display said image data there at the same time using a display device of the further terminal device and/or to store said image data in a corresponding image/video file, in particular together with audio signals synchronously recorded using a microphone device of the terminal device.

One development of the application software provides for the application to also be designed to display the image data from the front camera and from the rear camera in separate display areas or to display said image data at the same time in separate display areas using a display device of the further terminal device, the respective size of which areas preferably depends on a resolution of the relevant camera, the camera with the low resolution being assigned as standard to a smaller display area.

Another development of the application software provides for the application to also be designed to provide the user with a user interface which can be used by the user to change the display of the respective image data, preferably to switch said display on/off, to change the size of said display or to move a display position of said display and/or to control storage of the respective image data, most preferably by means of an external (Bluetooth) controller which can be or is connected to the terminal device.

The use of a digital terminal device in the form of a mobile device, such as a smartphone or the like, is also proposed, which use is distinguished by the fact that application software according to the fourth aspect of the invention is executed on the terminal device, the terminal device being used together with a holding apparatus to be arranged on the head of a user according to EP2103862 or EP2562462 or US2012/0175394 or DE 20 2009 009 326 or DE 20 2013 000 740.

Inspired by the Headflat®, the idea was developed whereby a user of a smartphone in combination with a Headflat® can use both cameras at the same time. The user can clamp his smartphone into the Headflat® and can use both cameras at the same time using the described software app which is accordingly configured. The signals from both cameras are combined in a data stream and are either stored on the device itself or are directly displayed on the monitor of a remote receiver device via a data connection, in particular an Internet connection.

This type of application is particularly suitable for explaining procedures in which it is advantageous if the listener can see the face and hands of the person providing the explanation of something (manual instructions or the like). It is also suitable for recording video diaries, for DJs or other artists for filming their appearances, generally for recording and transmitting video signals, especially for cooking programs and for teachers of any type.

According to a fifth aspect, the invention relates to a “head-type music stand” or comparable configurations.

Notes or music books are needed to learn to play instruments. These are generally placed on a music stand in order to arrange the notes optically at eye level and in a highly visible manner. Therefore, when playing a guitar or during a comparable activity, it is inevitable that one's gaze is averted from the instrument in order to read the next notes. In the case of many instruments, it is therefore necessary to continuously look back and forth between the hands or the instrument and the music book, which may give rise to problems for beginners, in particular. Similar problems arise when flipping through the notes. The invention is based on the object of remedying this.

This object according to the fifth aspect of the invention is achieved by means of application software for digital terminal devices in the form of mobile devices, such as smartphones or the like, preferably in downloadable form or in a form stored on a terminal device, during the execution of which a relevant terminal device provides an application having the following properties: A) the application is designed to access a file containing information, in particular texts or notes, which can be read by a user of the terminal device; and B) the application is designed to display the information sequentially, preferably word-by-word, sentence-by-sentence, or in the form of chords or music passages, on a display device of the terminal device.

One development of the application software provides for the application to also be designed to receive and evaluate a user input, preferably an acoustic user input via a microphone device of the mobile device, most preferably an acoustic input by means of a musical instrument or a voice input, and for the application to also be designed to display a next item of information on the basis of a result of the evaluation, preferably after the user input reproduces a currently displayed item of information in a sufficiently accurate manner within predetermined or predeterminable limits.

Another development of the application software provides for the application to also be designed to display, on the basis of control data in the file or at the request of the user, further media contents, such as acoustic contents, preferably music (accompaniment) or sounds (metronome), or optical contents, preferably images or videos, in addition or as an alternative to said information by means of the terminal device.

In this context, the use of a digital terminal device in the form of a mobile device, such as a smartphone or the like, is also proposed, which use is distinguished by the fact that application software according to the fifth aspect of the invention is executed on the terminal device, the terminal device being used together with a holding apparatus to be arranged on the head of a user according to EP2103862 or EP2562462 or US2012/0175394 or DE 20 2009 009 326 or DE 20 2013 000 740.

If the Headflat® is used while playing a guitar, a piano or other instruments, for example, according to the proposed use, the notes can be displayed using the device which is clamped into the Headflat®. If a guitar, for example, is then played, the gaze no longer needs to be averted from the hands during playing since both notes and the instrument are in the field of vision. It is thus possible to play an instrument without flipping through music books or turning the head to and fro.

Furthermore, this results, as a development of the invention, in a smartphone app which preferably independently recognizes the chords, passages or notes played and—after recognition within predefinable discrepancies in terms of pitch, tone length and/or beat or rhythm—displays the next notes to be played. This can be used as a learning app, in particular. A guitar chord, for example, is stored in the app and the software uses a recorded audio signal to check whether the player has correctly played the chord. Only then is a new chord displayed. In the case of (repeated) errors, the app can additionally or alternatively display an instruction or an instructional video or can reduce the tempo of the sequential display.

In that context, the use is also suitable, in particular, for learning vocabulary (correct word? correct pronunciation?), for recording karaoke or as a video diary.

A sixth aspect of the invention deals with a new possibility for remotely controlling toys, models and other electronic objects, in particular radio-remote-controlled electronic objects, such as robots, vacuum cleaners, lawnmowers, pool cleaning devices, drones or the like.

Many modern toys, for example remote-controlled automobiles, ships, helicopters, multicopters or aircraft, can by now be controlled by means of smartphones or comparable devices using so-called apps. This is generally implemented in such a manner that the toy is connected, without restriction, to the smartphone using Bluetooth or WLAN. Tapping on the touchscreen or tilting the devices (position or motion sensors) can then be used there to transmit a command, for example for acceleration or steering, to the toy in order to control the latter. Some devices also make it possible to transmit a video signal to the smartphone in the same way. In this case, the user of the smartphone has a view as if he were himself sitting in the toy. A considerable problem with such applications is that the smartphone must be held in the hand the entire time and the control options are not particularly convenient on account of the comparatively small monitors. The invention is based on the object of remedying this.

This object is achieved by means of application software for digital terminal devices in the form of mobile devices, such as smartphones or the like, preferably in downloadable form or in a form stored on a terminal device, for controlling real objects, preferably for controlling the motion of real objects, for example RC model automobiles, ships or aircraft, lawnmowers, vacuum cleaners or domestic robots, during the execution of which a relevant terminal device provides an application having the following properties: A) the application is designed to generate control signals for controlling a relevant object and to transmit them to the object to be controlled; B) the application is designed to generate said control signals by virtue of movement of the mobile device itself using corresponding motion sensors and/or if parts of the mobile device, in particular a touchscreen, are touched; and C) the application is also designed to provide the user with a user interface which can be used by the user to additionally or alternatively control the relevant object and/or particular additional functions of the object, preferably by means of an external controller which can be or is connected to the terminal device, most preferably a Bluetooth controller.

One development of the application software provides for the application to also be designed to display, for the user, image data from a camera placed in the object on a display device of the terminal device.

The use of a digital terminal device in the form of a mobile device, such as a smartphone or the like, is also proposed, which use is distinguished by the fact that application software according to the sixth aspect of the invention is executed on the terminal device, the terminal device being used together with a holding apparatus to be arranged on the head of a user according to EP2103862 or EP2562462 or US2012/0175394 or DE 20 2009 009 326 or DE 20 2013 000 740.

If, without restriction, toys as described above and additionally a smartphone are used in conjunction with the Headflat®, there are additional and completely new possibilities for controlling an aircraft, for example. The flight direction and the altitude, for example, can be changed by tilting the torso and additional functions can be implemented, for example, using a controller held in the hand. If, for example, a camera is installed in the toy to be controlled and can transmit its image signal to the smartphone, the result is a realistic perspective as if the user himself were sitting as the pilot in the toy.

In a practical exemplary embodiment, normal remote-controlled aircraft and helicopters can be equipped with a camera, the image signal from which is transmitted “live” to the smartphone which is used in a manner clamped in the Headflat®. This is possible only with the Headflat® since the remote control for the device to be controlled usually has to be held in the hands. The new development therefore comprises the programming or use of an app in conjunction with the use of a Headflat® and a remote-controlled device (toy), for example an aircraft or helicopter.

The described application is also suitable, without restriction, for accordingly equipped lawnmowers, vacuum cleaners, and (domestic) robots.

### BRIEF DESCRIPTION OF THE DRAWINGS

Further properties and advantages emerge from the description of exemplary embodiments using the drawing.

FIG. 1 schematically shows the use of a smartphone with an additional controller and a special holding apparatus;

FIG. 2 schematically shows a first view of a typical smartphone;

FIG. 3 schematically shows a second view of a typical smartphone;

FIG. 4 schematically shows particular functional units of a typical smartphone;

FIGS. 5a-d schematically show different uses of a smartphone within the scope of the first aspect of the present invention;

FIG. 6 schematically shows a special data format in connection with the first aspect of the invention;

FIG. 7 schematically shows the use of a smartphone in connection with the second aspect of the present invention;

FIG. 8 schematically shows the use of a smartphone according to the third aspect of the present invention;

FIG. 9 schematically shows the use of a smartphone according to the fourth aspect of the present invention;

FIG. 10 schematically shows contents displayed on a display of a smartphone in connection with the fourth aspect of the present invention;

FIGS. 11 and 12 schematically show the use of a smartphone according to the fifth aspect of the present invention; and

FIG. 13 schematically shows the use of a smartphone according to the sixth aspect of the present invention.

### DETAILED DESCRIPTION OF THE PREFERRED EMBODIMENTS

FIG. 1 schematically illustrates the use of a mobile digital terminal device (also referred to as “smartphone” below without restriction) which is denoted overall with the reference symbol 1. The smartphone 1 is arranged on a special holding apparatus 2 (the Headflat®) which is arranged on headgear 3 on the head 4 of a user 5. Such a holding apparatus 2 is known per se, to which reference has been repeatedly made in the present description. It makes it possible to conveniently place the smartphone 1 in the field of view of the user 5 without the user 5 having to use his hands 6 for this. The hands 6 of the user 5 are therefore free to hold and actuate additional objects, such as the Bluetooth controller 7 which is schematically illustrated in FIG. 1 and can be connected to the smartphone 1 using signaling in order to control the smartphone 1 or application software (app) executed on the latter, which will be discussed in yet more detail further below.

However, the present invention is not restricted in any way to the use of a special holding apparatus 2 for the smartphone 1. In principle, it is possible to use all types of holding apparatuses for smartphones which make it possible for the user 5 to respectively operate the smartphone 1 as required. However, as the subsequent description will show, it is advantageous for many applications if the user 5 has his hands 6 free in the manner shown and, at the same time, has a view of the display device (display 1a) of his smartphone 1 in a locally flexible manner.

FIG. 2 schematically shows, in a simplified form, a first view of a typical smartphone 1. The smartphone 1 has a display device (display) 1a which is usually touch-sensitive, that is to say in the manner of a touchscreen, and is therefore also used to operate the smartphone 1. The display 1a is enclosed in a housing body 1b of the smartphone 1. In addition to the display 1a, the housing body 1b comprises at least a number of operating elements 1c-1e and an audio recording device (microphone) 1f. An image recording device (camera) is also schematically illustrated at reference symbol 1g and, in the form of a so-called rear camera, usually has a relatively low resolution.

It goes without saying that the invention is not restricted to smartphones 1 designed in this manner; as already stated, the illustration in FIG. 2 should be understood in a purely schematic manner in order to be able to better explain particular terms essential to the understanding of the invention. The same applies to the illustration in FIG. 3 which shows a different view of a typical smartphone 1.

On the front illustrated in FIG. 3, the smartphone 1 usually has a further camera 1h which, in the form of a so-called front camera, usually has a relatively high resolution in comparison with the rear camera 1g (cf. FIG. 2). An audio output device (loudspeaker) of the smartphone 1 is also illustrated at reference symbol 1i.

FIG. 4 schematically shows functional units of a typical smartphone 1 which are important for the present invention. Elements already explained in connection with other Figures have the same reference symbols here and below.

The core of the smartphone 1 is the processor which is illustrated at reference symbol 1j and controls the operation of the smartphone 1. Special application software (also referred to as software app or app for short) is symbolically illustrated at reference symbol 1k inside the processor 1j and is executed by the processor 1j in order to carry out particular functions which are important within the scope of the invention, to which reference has already been made in the introductory part of the description. In addition to the processor 1j, the smartphone 1 also comprises at least the display device 1a which has already been described, the audio output device 1i which has likewise already been described, a memory unit 1l, the cameras 1g, 1h which have already been described and the audio recording device 1f which has likewise already been described. In addition, the smartphone 1 also comprises a first transmitting/receiving device 1m for wirelessly communicating with other smartphones (illustrated by way of example at reference symbol 1), preferably via a computer network (Internet) and/or a telephone network, and a second transmitting/receiving device 1n for wirelessly communicating with further devices, the controller 7 in the present case, which second transmitting/receiving device 1n is specifically designed for using a Bluetooth standard.

As can also be gathered from FIG. 4, the memory unit 1l stores application data 1p which, in the present case, correspond to a program code needed for the execution of the app 1k by the processor 1j. Furthermore, the memory unit 1l also stores further data 1q which are accessed by the app 1k during its execution. This is discussed in yet more detail further below.

As discerned by a person skilled in the art, the data 1p and 1 q need not be stored in the same memory unit 1l. Rather, the smartphone 1 may have a plurality of volatile and/or non-volatile memory units in order to hold required data in a suitable manner, which is known per se to a person skilled in the art. For example, required data may also be downloaded, in a purely temporary form, from a computer or telephone network via the transmitting/receiving devices 1m, 1n, in which case permanent storage on the smartphone 1 is not required under certain circumstances.

Reference symbol 1r denotes position and/or motion sensors of the smartphone 1, the signal from which can be evaluated by the processor 1j and can be used for control purposes.

The (double-headed) arrows in FIG. 4 illustrate particular data flows inside the smartphone 1 and to further devices 1′, 7 connected to the smartphone 1. For example, the cameras 1g, 1 h provide the processor 1j with corresponding image data for further processing. The microphone if likewise provides the processor 1j with audio data. Conversely, the processor 1j provides the display 1a with display data. Furthermore, the processor 1j interchanges data with the memory unit 1l, for example in order to read data from the memory unit 1l and/or to write data to the memory unit 1l. In addition, the processor 1j provides the loudspeaker 1i with data. The (double-headed) arrows outside the smartphone 1 symbolize communication with the further smartphone 1′ or the controller 7 using the relevant transmitting/receiving devices 1m, 1n.

As is also illustrated in FIG. 4, the controller 7 comprises a first actuating element 7a, in particular a pushbutton, and a second actuating element 7b which, in the present case, is in the form of a directional pad for direction control. Such controllers 7 are known to a person skilled in the art. They may have further actuating elements for multimedia contents, which is not illustrated in the present case. The important factor is that the smartphone 1 or particular functions of apps 1k executed on the smartphone 1 can be controlled using the controller 7, to which reference is repeatedly made below.

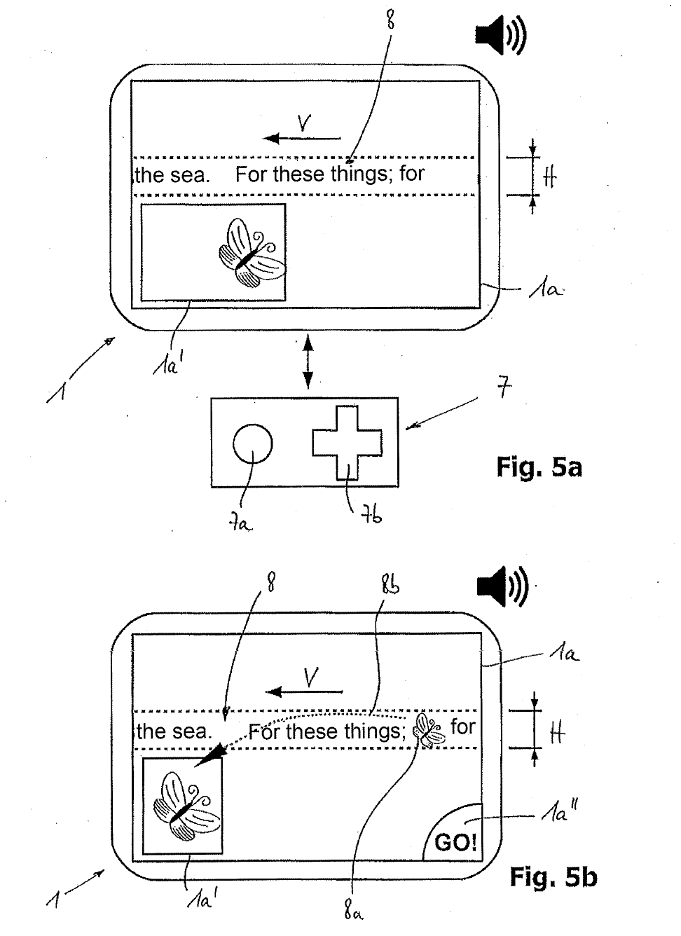

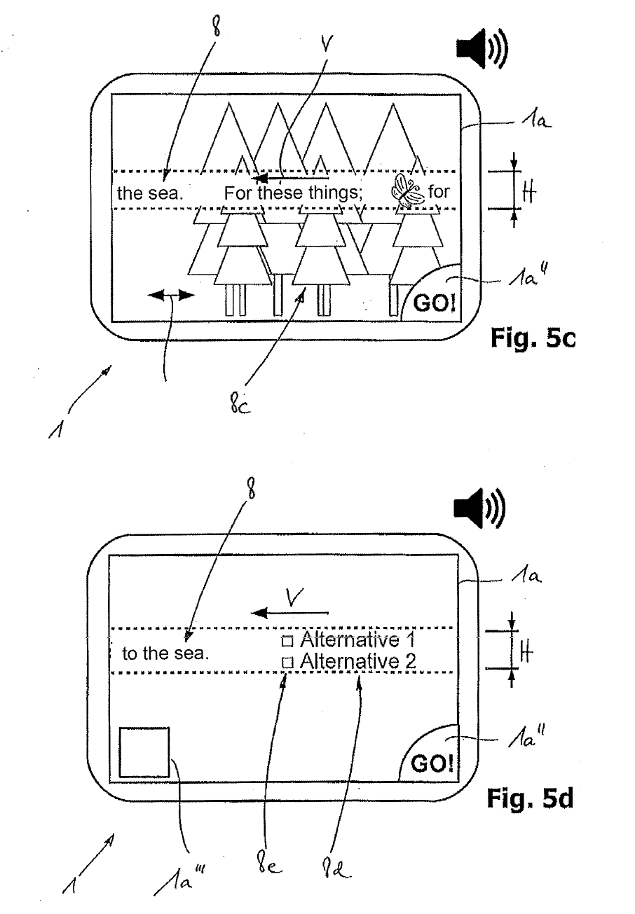

FIG. 5a schematically illustrates a first use of the smartphone 1 according to the first aspect of the invention. In this context, the smartphone 1 functions as a novel e-book reader and, for this purpose, is configured, in terms of software, by means of a suitable app 1k (cf. FIG. 4) in such a manner that text to be read is displayed as scrolling text 8 on the display 1a of the smartphone 1. Particular parameters of the scrolling text display, in particular the text height H and/or the scrolling speed V, can be controlled by the user by means of the controller 7. In principle, however, this configuration is not restricted to the use of a separate controller 7; rather, corresponding operating elements may also be provided on the smartphone 1, for example in a suitable area of the display 1a, in order to control parameters of the application (cf. FIGS. 5b-d).

However, it is particularly preferred to use a separate controller 7 because it is then possible to control the scrolling text 8, for example by actuating the element 7a, in such a manner that the scrolling text is moved only with continued pressing of the operating element 7a. As soon as the user releases the button 7a, the scrolling text 8 stops and the reading process can be interrupted.

The output of image/video data in a special display area 1a′ of the display 1a is also symbolically illustrated in FIG. 5a. The additional loudspeaker symbol (cf. reference symbol 1i in FIG. 3 and FIG. 4) illustrates the additionally possible output of audio data.

As is easily discerned by a person skilled in the art, the screen output is not restricted to the arrangement illustrated by way of example in FIG. 5a. The scrolling text 8 may also be arranged at the top or bottom edge of the display, for example. Instead of only one display area 1a′, a plurality of such display areas may be provided. The display area 1a′ may also be arranged behind the scrolling text 8 in the manner of a background image. The important factor is only that text to be read in the illustrated manner can be supplemented with further media contents, which is preferably carried out with content-based (temporal) coordination between the text currently displayed and said further media contents.

FIG. 5b schematically illustrates a second use of the smartphone 1 according to the first aspect of the invention. In this context, the smartphone 1 likewise functions as a novel e-book reader and, for this purpose, is again configured, in terms of software, using a suitable app 1k (cf. FIG. 4) in such a manner that text to be read is displayed as scrolling text 8 with a scrolling speed V on the display 1a of the smartphone 1. The configuration according to FIG. 5b manages without an external controller; for this purpose, an operating area is provided in the display 1a at reference symbol 1a″ and the scrolling text 8 moves when said operating area is (permanently) touched. It goes without saying that other operating modes are possible. An image which is integrated in the scrolling text is illustrated at reference symbol 8a, which image is coupled out when a pre-definable position is reached according to the arrow 8b and is then (permanently) displayed in the display area 1a′ below the line of text. It can be activated there as a link (by means of tapping) in order to retrieve associated background information, for example from the Internet.

FIG. 5c schematically illustrates a third use of the smartphone 1 according to the first aspect of the invention. In this context, the smartphone 1 likewise functions as a novel e-book reader and, for this purpose, is again configured, in terms of software, by means of a suitable app 1k (cf. FIG. 4) in such a manner that text to be read is displayed as scrolling text 8 with a scrolling speed V on the display 1a of the smartphone 1. The configuration according to FIG. 5c also shows a background image 8c which is moved more slowly than the text according to the double-headed arrow V′ and is preferably selected in a manner matching the instantaneous contents of the text, that is to say the contents currently passing through.

FIG. 5d schematically illustrates a fourth use of the smartphone 1 according to the first aspect of the invention. In this context, the smartphone 1 likewise functions as a novel e-book reader and, for this purpose, is again configured, in terms of software, by means of a suitable app 1k (cf. FIG. 4) in such a manner that text to be read is displayed as scrolling text 8 with a scrolling speed V on the display 1a of the smartphone 1. The configuration according to FIG. 5d also shows two alternatives at reference symbol 8d, the respective selection of which, by tapping on one of the selection symbols 8e, results in a branch in the running of the text. In other words: depending on the selection 8e, either the text for alternative 1 or the text for alternative 2 is displayed as scrolling text 8. The scrolling text 8 advantageously stops when the selection symbols 8e are reached in order to provide the user with the required leisure during selection.

Reference symbol 1a″ denotes a so-called social web field, that is to say a touch-sensitive area of the display 1a, which, when touched, makes it possible to readily publish previously marked text (for example by repeated tapping) on Facebook or other portals, depending on the configuration of the app 1k, via a social web interface provided by the smartphone 1.

The possible configurations shown in FIGS. 5a to d can be combined with one another in virtually any desired manner depending on the type of text to be displayed (advertising, news, non-fiction book, children's book, etc.).

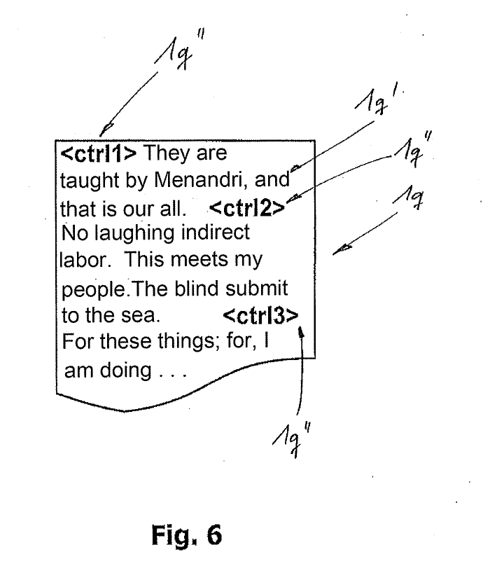

In this context, reference is made to the following FIG. 6. FIG. 6 schematically shows data and a special data format which can be used in connection with the first aspect of the invention (cf. reference symbol 1q in FIG. 4). The data format and the relevant data 1q comprise, on the one hand, the text 1q′ to be displayed as scrolling text 8 (cf. FIG. 5). The data 1q also comprise control data 1q″ which are denoted with <ctrl#> in the present case. If the e-book reader app now processes the data 1q in order to display the scrolling text 8 (cf. FIG. 5), the control data 1q″ ensure that, in order to reach the respective control data item during the display of the text, further media contents are displayed, for example in the display area 1a′ (cf. FIG. 5) mentioned further above and/or by means of an audio output and/or inside the scrolling text. Said further contents can be stored together with the data 1q. Separate storage with corresponding linking is also possible, which shall not be discussed any further in the present case. The important factor is only that the relevant app 1k (FIG. 4) “knows”, upon reaching the control data 1q″, which further data need to be displayed when, where and in what manner by means of the smartphone 1 in addition to the scrolling text 8 (cf. FIG. 5). A reading experience enriched with media therefore results, in which case a text editor can take the reader “by the hand” as it were in terms of media.

FIG. 7 illustrates another aspect of the present invention. This is fundamentally not restricted to the presence of a plurality of users 5, 5′, even though this is illustrated in this manner in FIG. 7. Each user 5, 5′ uses a smartphone 1, 1′ with a corresponding holding apparatus 2, 2′ (cf. FIG. 1). In addition, each user 5, 5′ has a controller 7, 7′. An actually existing object, a game board in the present case, is illustrated at reference symbol 9. However, this actually existing object 9 could also be a toy, for example a Playmobil® or Lego® toy, for example a vehicle or a spaceship.

The sequences described below are again controlled by a suitable app 1k (cf. FIG. 4) which is executed on the smartphone 1, 1′ of the relevant user 5, 5′.

The smartphone 1 first of all identifies the game board 9, a game board for the known game “Schiffe versenken” in the present case, using the camera 1h (cf. FIG. 3 or FIG. 4). The game board 9 therefore provides a fixed point as the display basis for the smartphone 1. The user 5 is then able, by means of the controller 7, to place his own ships as purely virtual objects on a virtual image of the playing field 9 inside the virtual gaming environment provided by the app. These ships or virtual objects are denoted in FIG. 7 with the reference symbols S1 to S3. A corresponding situation applies to the further user 5′ (virtual objects S1′ to S3′). In this case, only the user's own virtual playing field VE, VE′ is respectively displayed for each user 5, 5′ via his smartphone 1, 1′, with the result that there is no need to set up barriers or the like, as is required in the conventional board game variant. Additionally or alternatively, the virtual playing field of the opponent VG, VG′ without the virtual objects S1-S3 and S1′-S3′ placed there is displayed for each player or user 5, 5′, onto which the respective player 5, 5′ fires his “shots” with the aid of the controller 7, 7′. The player's own hits and misses and the opponent's hits and misses are accordingly displayed on the virtual playing field, as conventionally takes place with the aid of crayons or plug-in elements. It goes without saying that additional media contents (sounds, images, videos) can be displayed on the smartphone 1, 1′ in this case.

It is within the scope of the invention for the smartphone to automatically start the relevant app upon identifying the real object 9 in order to start the game.

In FIG. 7, the solid lines illustrate a corresponding indication on the display 1a, 1a′ of the smartphone 1, 1′. The dash-dotted lines, which are depicted only for the left-hand user 5 for reasons of clarity, symbolize the identification of the real object 9 by the smartphone camera.

As is easily discerned by a person skilled in the art, this aspect of the invention is not restricted to the (board) game shown here. If, for example, a Lego® spaceship is used as the real object 9, this object and its image can then be displayed on the smartphone together with further virtual objects, such as aliens, monsters, astronauts or the like, which are then concomitantly included in a game to be controlled using the controller 7.

In this case, it is advantageous that the user 5 can use his hands 6 to operate the controller 7 on account of the holding apparatus 2 used, because the user does not have to hold the smartphone 1.

FIG. 8 illustrates another aspect of the present invention. The user 5 is consequently, by way of example, a customer of an automobile showroom and would like to examine a new automobile model there in different equipment variants. This is carried out virtually by means of a smartphone and an app 1k (cf. FIG. 4) executed on the latter. In a similar manner to the description of FIG. 7, the smartphone camera identifies a real object which is present in the showroom and provides a fixed point as a display basis. This may be an image code which also ensures that the app is loaded and/or started following identification by the smartphone 1. The desired automobile model 10 is presented virtually to the user or customer 5 on the display 1a of the smartphone 1, in which case the user or customer can change equipment variants of the automobile 10 in any desired manner using the controller 7. On account of the shown arrangement of the smartphone 1 in the holding apparatus 2, the user or customer can walk around the virtual automobile 10 in this case without any spatial restriction, which automobile is accordingly shown to the user or customer in different views, to be precise in the respectively selected model variant.

Such applications are also highly suitable for furniture showrooms or furniture stores, for “inspecting” architecture models or for comparable applications.

FIGS. 9 and 10 illustrate another aspect of the present invention which is based on the fact that both the rear camera 1g and the front camera 1h of the smartphone 1 are used at the same time by means of a suitable app 1k (cf. FIG. 4). In this case, the smartphone 1 can—but need not—be fixed in a holding apparatus 2 fastened to the head of the user 5.

The dash-dotted lines in FIG. 9 illustrate the recording area of said smartphone cameras. Whereas the rear camera films the face of the user 5, the front camera can be used to film the hands of the user 5 and/or another object. The arrow in FIG. 9 illustrates that the combined front and rear image data from the smartphone 1 can then be transmitted to a further smartphone 1′. However, local storage on the smartphone 1 is also possible, for example for the purpose of creating a video diary.

FIG. 10 illustrates the form in which the acquired image data are then displayed for a user (not shown) of the further smartphone 1′. For this purpose, the display 1a′ there comprises an embedded display area 1a″ in which the rear image data from the smartphone 1 are displayed, that is to say the face of the user 5 in the present case. The image data from the smartphone 1 which are acquired on the front are displayed in the remaining display area 1a′, that is to say the hands 6 of the user 5 in the present case.

In this manner, it is possible, for example, to practically perform a particular manual activity for a user of the smartphone 1′ and to show it by video, while the relevant user simultaneously also sees the face of the person providing the explanation, that is to say the user 5 of the smartphone 1 in the present case. This may be very advantageous for all kinds of teaching applications, in particular.

The corresponding app may provide for the size and/or relative arrangement of the respective display areas for the front and rear image data to be changed in any desired manner, for example enlarged, and/or to be temporarily hidden.

The configuration described above is also suitable, in particular, for video chat applications because in this manner a chat participant can be shown both the face of his conversation partner and the current (actuation) environment thereof.

FIGS. 11 and 12 illustrate another aspect of the present invention, in which case a user 5 of the smartphone 1, which is arranged in a holding apparatus 2, is provided, via the display 1a of the smartphone 1, with a display of parts of a piece of music which is symbolized in the present case by the notes at reference symbol 1l. The user 5 can therefore play or sing the displayed notes using a musical instrument without having to be locally tied, for example at a conventional music stand. There is also no need to flip through notes if the piece of music and the relevant notes are continuously displayed on the smartphone 1. This is advantageous, in particular, in the case of musical instruments which are held with the hands, such as the guitar 12 illustrated by way of example in FIG. 12. If necessary, a controller in the form of a foot switch or the like can also be used in this context to “flip through” the notes.

FIG. 12 illustrates another special development of this idea which additionally uses the microphone 1f of the smartphone 1.

The app 1k (cf. FIG. 4) which is used as part of the application according to FIG. 11 and FIG. 12 may be designed to record and evaluate sounds generated by the user 5, with the result that new notes 1l are displayed for the user 5 when the user has completely and/or correctly played the relevant music. It goes without saying that it is also possible in this context to display the notes 1l continuously in the manner of scrolling text (cf. reference symbol 8 in FIG. 5). This option comes into consideration for advanced users, in particular. The possible use of a controller has already been pointed out.

This aspect of the invention is also suitable, in a comparable manner, as a vocabulary trainer by virtue of words or phrases being displayed for the user 5, which words or phrases must be correctly repeated and/or translated and/or supplemented by the user before there is a new display.

FIG. 13 shows the use of a smartphone 1 according to another aspect of the invention. In this context, the user 5 uses the smartphone 1 together with a holding apparatus 2 which is attached to the head and a controller 7 for controlling a model helicopter 13. A camera 14 which simulates the view of a pilot from the cockpit of the helicopter 13 is arranged in the helicopter 13. The relevant image from the camera 14 is transmitted to the smartphone 1 and is displayed for the user 5 using the display 1a of the smartphone 1. Since the user 5 has his hands 6 free on account of the use of the holding apparatus 2, he can use the controller 5 to control additional functions which are provided on the helicopter 13 itself, that is to say actually, or are provided virtually using the app 1k (cf. FIG. 4) which is executed on the smartphone 1.

For this purpose, the camera display on the display 1a of the smartphone 1 is advantageously supplemented with virtual objects (augmented reality), such as persons to be rescued, obstacles or the like, with which the user 5 or the helicopter 13 can interact in the game, that is to say virtually.

The controller 7 is used for this purpose and can be used by the user 5 to influence the game and, in particular, also to control the helicopter 13. For example, the operating element 7b illustrated in FIG. 4 can be used to control the actual helicopter 13, whereas the further operating element 7a is used to fire virtual rockets in the app, to rappel rescue personnel or the like.

Since the user 5 is locally independent on account of the use of the holding apparatus 2, he can also control the helicopter 13 by means of body movements using the motion sensors 1r of the smartphone 1 which are shown in FIG. 4. This produces an integrated gaming experience which is no longer restricted solely to the hands 6 and the controller 7 but concomitantly includes the entire body of the user 5.

The application is not restricted to controlling aircraft according to FIG. 13 but rather is suitable, in principle, for all remote-controlled devices irrespective of whether or not they are equipped with a camera 14. The smartphone display can also be restricted, in principle, to purely virtual data provided by the app.

1. An application software (1p) for digital terminal devices (1), in a form stored on a terminal device, during the execution (1k) of which a relevant terminal device provides an application having the following properties:
the application accesses a file (1q) containing text (1q′) which is readable by a user (5) of the terminal device (1); and
the application displays the text sequentially in a form of or a scrolling text (8) on a display device (1a) of the terminal device (1).

2. The application software (1p) as claimed in claim 1, wherein
the application provides the user (5) with a user interface (1a″) which is used by the user (5) to control a display speed (V) of the text scrolling speed of the scrolling text (8), or a display size (H) of the text, by an external controller (7) which is connected to the terminal device (1).

3. The application software (1p) as claimed in claim 1, wherein
the application to displays further media contents (8a, 8c), including at least one of acoustic contents or optical contents, in addition or as an alternative to the text (1q′) or the scrolling text (8) based on control data (1q″) in the file (1q) by the terminal device (1) or based on a position reached on a display device (1a) of the terminal device (1), or both.

4. A data format (1q) for use with application software (1p) as claimed in claim 1, wherein
in addition to text (1q′) which is readable by people (5) at least after being suitably displayed by a digital terminal device (1), the data format contains control data (1q″) which, based on predetermined passages, refer to additional media contents, including at least one of acoustic contents or optical contents, which contents are stored inside the same data format or separately, in order to cause the terminal device (1), when the text (1q′) is displayed sequentially in the form of the scrolling text (8) by a digital terminal device (1), to display the additional media contents (8a, 8c) in addition or as an alternative to the text (1q′) or the scrolling text (8) based on the reaching of the control data (1q″) in a time-controlled manner or on the basis of a position reached on a display device (1a) of the terminal device (1) or both.

5. A digital terminal device (1), that displays readable text (1q′) and additional media contents based on the text, comprising
application software (1p) as claimed in claim 1, that is executed on the terminal device and accesses a file containing the data format (1q),
the terminal device (1), in a configuration as a mobile device is connected to a holding apparatus (2) to be arranged on the head of a user (5).

6. Application software (1p) arranged on a tangible media for digital terminal devices (1) in the form of mobile devices, in a form stored on a terminal device, during the execution (1k) of which a relevant terminal device provides an application having the following properties:
the application provides a digital gaming environment for a toy, said toy comprises a game board (9) or another physical object of a previously known geometry;
the application controls a camera device (1h) of the terminal device (1) or uses image data and, based the image data, after initial optical identification of a predetermined real object (9), dynamically displays virtual game objects (S1-S3; S1′-S3′) in a spatial relationship with the real object (9) depending on a game situation using a display device (1a) of the terminal device (1).

7. The application software (1p) as claimed in claim 6, wherein
the application provides the user (5) with a user interface which is used by the user to control game play, by an external controller (7) which is connected to the terminal device.

8. The application software (1p) as claimed in claim 6, wherein
the application communicates, via corresponding communication devices (1m) of the terminal device (1), with a further terminal device (1′) which executes the same application software (1p) in order to provide a multiplayer gaming environment with a plurality of players (5, 5′).

9. The application software (1p) as claimed in claim 8, wherein
the application displays, for the relevant player or user (5, 5′), only a part of a game situation which is intended for the player or user.

10. A digital terminal device (1) in the form of a mobile device, comprising
application software (1p) as claimed in claim 6, that is executed on the terminal device,
the terminal device is connected to a holding apparatus (2, 2′) to be arranged on the head of a user (5, 5′).

11. Application software (1p) for digital terminal devices (1) in the form of mobile devices, in a form stored on a terminal device, during the execution (1k) of which a relevant terminal device provides an application having the following properties:
the application provides and displays a digital version of an object known per se as a virtual object (10);
the application controls a camera device (1h) of the terminal device (1) or uses image data and, based on the image data, after initial optical identification of a predetermined real object (9), dynamically displays additional virtual objects or properties in a spatial relationship with the virtual object (10) based on at least one of a selection or position of the terminal device user (5) using a display device (1a) of the terminal device (1).

12. The application software (1p) as claimed in claim 11, wherein
the application provides the user (5) with a user interface which is usable by the user to select the additional virtual objects or properties by an external controller (7) which is connected to the terminal device.

13. The application software (1p) as claimed in claim 12, wherein
the application to displays, for the user (5), additional information relating to a current selection from a virtual object (10) and additional virtual objects or properties using a display device (1a) of the terminal device (1).

14. A digital terminal device (1) in the form of a mobile device comprising
application software (1p) as claimed in claim 11, that is executed on the terminal device (1),
the terminal device (1) being connected to holding apparatus (2) to be arranged on the head of a user (5).

15. The application software (1p) for digital terminal devices (1) in the form of mobile devices with a front camera (1h) and a rear camera (1g), in a form stored on a terminal device, during the execution (1k) of which a relevant terminal device provides an application having the following properties:
the application controls the front camera (1h) and the rear camera (1g) substantially at a same time or uses image data from the front or rear camera, or both;
the application dynamically displays the image data from the front camera (1h) and from the rear camera (1g) at the same time using a display device (1a) of the terminal device (1) or transmits said image data to a remote, further terminal device (1′), and dynamically displays said image data there at the same time using a display device (1a′) of the further terminal device or stores said image data in a corresponding image/video file.

16. The application software (1p) as claimed in claim 13, wherein
the application displays the image data from the front camera (1h) and from the rear camera (1g) in separate display areas (1a′, 1a″) or displays said image data at the same time using a display device of the further terminal device (1′), a respective size of which depends on a resolution of the relevant camera, the camera with the lower resolution being assigned as standard to a smaller display area.

17. The application software (1p) as claimed in claim 6, wherein
the application provides the user (5) with a user interface which can be is used by the user to change the display of the respective image data to change a size of said display or to move a display position of said display or to control storage of the respective image data.

18. A digital terminal device (1) in the form of a mobile device, comprising
application software (1p) as claimed in claim 15, that is executed on the terminal device (1),
the terminal device (1) being connected to a holding apparatus to be arranged on the head of a user (5).

19. Application software (1p) for digital terminal devices (1) in the form of mobile devices, in a form stored on a terminal device, during the execution (1k) of which a relevant terminal device provides an application having the following properties:
the application accesses a file (1q) containing information which is readable by a user (5) of the terminal device (1);
the application displays the information sequentially on a display device (1a) of the terminal device (1).

20. The application software (1p) as claimed in claim 19, wherein
the application receives and evaluates a user input of the mobile device (1), and
the application displays a next item of information based on a result of the evaluation.

21. The application software (1p) as claimed in claim 19, wherein
the application displays, based on control data in the file (1q), further media contents in addition or as an alternative to said information by the terminal device (1).

22. A digital terminal device (1) in the form of a mobile device, comprising
application software (1p) as claimed in claim 19, that is executed on the terminal device (1),
the terminal device (1) being connected to a holding apparatus (2) to be arranged on the head of a user (5).

23. Application software (1p) for digital terminal devices (1) in the form of mobile devices in a form stored on a terminal device, for controlling real objects (13) during the execution (1k) of which a relevant terminal device (1) provides an application having the following properties:
the application generates control signals for controlling a relevant object (13) and transmits the control signals to the object (13) to be controlled;
the application generates said control signals by virtue of movement of the mobile device (1) itself using corresponding motion sensors (1r) or if parts of the mobile device (1) are touched; and
the application provides the user (5) with a user interface which is used by the user (5) to additionally or alternatively control the relevant object (13) or particular additional functions of the object, or both.

24. The application software (1p) as claimed in claim 23, wherein
the application displays, for the user, image data from a camera (14) placed on the object (13) on a display device (1a) of the terminal device (1).

25. A digital terminal device (1) in the form of a mobile device, comprising
application software (1p) as claimed in claim 23, that is executed on the terminal device (1),
the terminal device (1) being connected to a holding apparatus (2) to be arranged on the head of a user (5).
